(19) United States
(12) Patent Application Publication
(10) Pub. No.: US 2009/0168091 A1
(43) Pub. Date: Jul. 2, 2009

(54) METHOD AND SYSTEM FOR PROVIDING EXTENDED PRINTER PROPERTIES

(75) Inventors: Arron FU, Toronto (CA); Andrew KRAWCZYK, Mississauga (CA); Paul Michael SLOBODIAN, Mississauga (CA); Joel BEAULNE, Toronto (CA)

Correspondence Address: SMART & BIGGAR, 1000 DE LA GAUCHETIERE ST. W., SUITE 3300, MONTREAL, QC, H3B 4W5, CA

(73) Assignee: BCE INC., Montreal (CA)

(21) Appl. No.: 12/055,804

(22) Filed: Mar. 26, 2008

Related U.S. Application Data
(60) Provisional application No. 61/017,949, filed on Dec. 31, 2007.

(51) Int. Cl. G06F 15/00

(52) U.S. Cl. 358/1.15

(57) ABSTRACT

A method for providing extended printer properties to a thin client is described. The method comprises communicating with a print server associated with a printer to scrape or grab an image of an extended printer properties interface for the printer from the print server display. The scraped image is then displayed at the client. User inputs input by a user on the image are then communicated to the print server for application to a print job. Changes to the displayed image, resulting from the user inputs, can be returned to the client. The print job can be transmitted to the print server in portable document format. A print server and a distributed computing network for implementing the method are also described.

### CROSS-REFERENCE TO RELATED APPLICATIONS

This application claims the benefit of U.S. Provisional Application Ser. No. 61/017,949, filed Dec. 31, 2007, the contents of which are incorporated herein by reference in their entirety.

### FIELD OF THE INVENTION

The present invention relates generally to printing in distributed computing environments. More particularly, the present invention relates to providing extended printer properties in a distributed server-based computing environment.

### BACKGROUND OF THE INVENTION

While server-based computing (SbC) has simplified administration, and effectively lowered the operating costs of many IT departments, it can increase complications associated with printing. Printers are purchased based on features and price, but not necessarily on how they integrate into an environment. SbC forces administrators to rethink their printing architecture and implementation—efficient stable printing cannot be taken for granted in a SbC environment. SbC administrators must consider a variety of issues and problems, including lack of support for a vast number of remote printing devices, only partial use of a print device's full feature set, and limited thin client printing support

Standard printer properties, such as paper size, orientation, collate, page range, etc., are generally provided by all printer drivers and are standardized by, for example, the Windows™ operating system printing model. Extended printer properties are private or proprietary properties that are specific to individual printer manufacturers. The extended printer properties can include any features supported by the particular printer. Common extended printer properties include features such as stapling, graphic options (e.g. toner darkness, picture grade), data compression, etc. Printer properties dialog boxes are generally presented to users upon clicking the ‘Print’ button. Such dialog boxes allow users to specify or select printing options that are to be applied to the print job. If the printer drivers of the target printer are installed locally, the user can generally access and modify all standard and manufacturer-specific (i.e. extended) printer properties.

Printing from applications running within a distributed or SbC environment typically requires that printer drivers be installed on the same central server that is hosting the user's application. In such SbC environments, many users connect to a central server, such as a Citrix MetaFrame™ (also known as Citrix Presentation) server or Microsoft Terminal Services™ server, and printer drivers must be installed on the central server for all possible printers to which users may desire to print. As the number of printers in an organization increases, this can lead to an administrative nightmare. In large SbC implementations, administrators may not only be required to manage a large number of diverse printers and their associated printer drivers, but may also have to deal with multiple printer locations, and the availability of specific printers at each location.

Universal printer driver solutions are known. A universal printer driver, providing a single printer driver for all types of printers, can be installed on the central server to help reduce SbC printer administration. For example, in one known implementation, all documents are sent to a print server in compressed portable document format (PDF). The print server hosts the native printer drivers used to render print jobs for the specific printers with which it is associated. The print server processes print jobs it receives using a PDF interpreter and the requested native printer driver. Print jobs are then sent from the print server to the appropriate printer. Sending documents to the print server in compressed PDF reduces bandwidth consumption, making printing to remote offices over Virtual Private Network (VPN) or Wide Area Network (WAN) connections faster, more efficient and reliable.

It is also known to have a centrally managed printer access point for all printers associated with various print servers connected to a central server. In such an implementation, all participating nodes, such as the central server, spool server, and print servers, maintain a connection to one another. When thin-client or managed workstation users print in this type of SbC environment, print jobs are spooled as PDF compatible files and are sent to the spool server, from where they are transmitted to the appropriate print servers. The print server processes print jobs it retrieves using a PDF interpreter and the requested native printer driver. Print jobs are then sent from the print server to the appropriate printer

In both these cases, however, the central server typically displays a default or standard user interface (or dialog box) showing standard printer preferences, such as paper size, number of copies, portrait vs. landscape etc., for all print jobs. The user is not provided access to a selected printer's full range of manufacturer-specific, or extended, printer properties, unless the appropriate printer driver is loaded on the user workstation or the central server. Accordingly, the user is not able to modify the extended printer properties, and the selected printer's full functionality may not be fully exploited.

It is, therefore, desirable to provide a user access to extended printer properties a server-based or distributed computing environment without requiring that printer-specific printer drivers be loaded on the user's workstation or the central server.

### SUMMARY OF THE INVENTION

In a first aspect, there is provided a method for providing extended printer properties to a client in a server-based computing environment. The method comprises communicating with a print server associated with a printer device to retrieve an image of an extended printer properties interface for the printer device, which is then displayed at the client. User inputs input by a user on the image of the extended printer properties interface are then communicated to the print server for application to a print job. The print job can be transmitted to the print server in portable document format.

According to embodiments, the method can further comprise first receiving a request for extended printer properties from the client, such as a print job request from the client. Communicating with the print server to retrieve the image of the extended printer properties interface can comprise retrieving a template image of the extended printer properties interface for the printer device, which can be, for example, a previously stored template image associated with the client or the user. Communicating with the print server can also comprise establishing a secure connection, such as establishing a tunnel over a Transmission Control Protocol (TCP) connection. Causing the image of the extended printer properties interface to display at the client can comprise scraping the image at the print server, and displaying the scraped image at the client. The user inputs can be received at a central server in communication with the client and relayed to the print server. The method can further comprise updating the image displayed at the client in accordance with the user inputs. Only the updated portion of the image needs to be transmitted to the client, and this can be done in real-time.

According to a further aspect, there is provided a print server for providing extended printer properties to a client in a server-based computing environment. The print server comprises a memory, an imaging process and a print process. The memory stores a printer driver for a printer device associated with the print server, which includes extended printer properties. The imaging process provides an image of an extended printer properties interface associated with the printer driver to a client and receives user inputs related to the extended printer properties interface to define user selections of the extended printer properties. The print process applies the user selections to a print job.

According to embodiments of the print server, the extended printer properties interface can be an extended printer properties dialog box. The print server can comprise a communications port to establish a secure communication channel with the client. The secure communication channel can be, for example, established according to a tunneling protocol. On receipt of user inputs, the imaging process can update the extended printer properties interface at the print server, and transmit an updated portion of the image to the client. The image can be transmitted in real-time.

According to yet another aspect, there is provided a server-based computing network providing extended printer properties to a client. The network comprises a central server and a print server. The central server can be, for example, a Citrix MetaFrame™ server or a Microsoft Terminal Services™ server. The central server can also implement a Virtual Desktop Infrastructure (VDI). The central server receives, from the client, a request for extended printer properties associated with a networked printer device. The print server is in communication with the central server, and has loaded thereon a printer driver associated with the networked printer device. The print server also has an imaging process to provide a snapshot of an extended printer properties interface associated with the printer driver for display at the client, and to receive user selections defining extended printer properties to apply to a print job.

According to embodiments of the network, the client can operate as a thin client. A spool server can be interposed between the central server and the print server to spool print jobs to a plurality of print servers. The print server can communicate with the central server over a secure communication channel, such as a tunnel. On receipt of user selections, the imaging process can update the extended printer properties interface at the print server, and can transmit an updated portion of the image to the client. The updated portion of the image can be transmitted in real-time.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a diagram of an embodiment of a system for providing extended printer properties to a thin client;

FIG. 2 is a further diagram of the system for providing extended printer properties to a thin client;

FIG. 3 is a flowchart of a method for providing extended printer properties to a thin client; and

FIG. 4 is a further embodiment of a system for providing extended printer properties to a thin client.

### DETAILED DESCRIPTION

The present invention provides a user with access to the extended printer properties of remotely installed printers, without the need for the printers' drivers to be present in the user environment. The present invention is particularly useful for printing from thin clients in a server-based computing (SbC), or distributed computing, environment using a universal printer driver solution that provides print jobs to print servers in a portable document format (PDF).

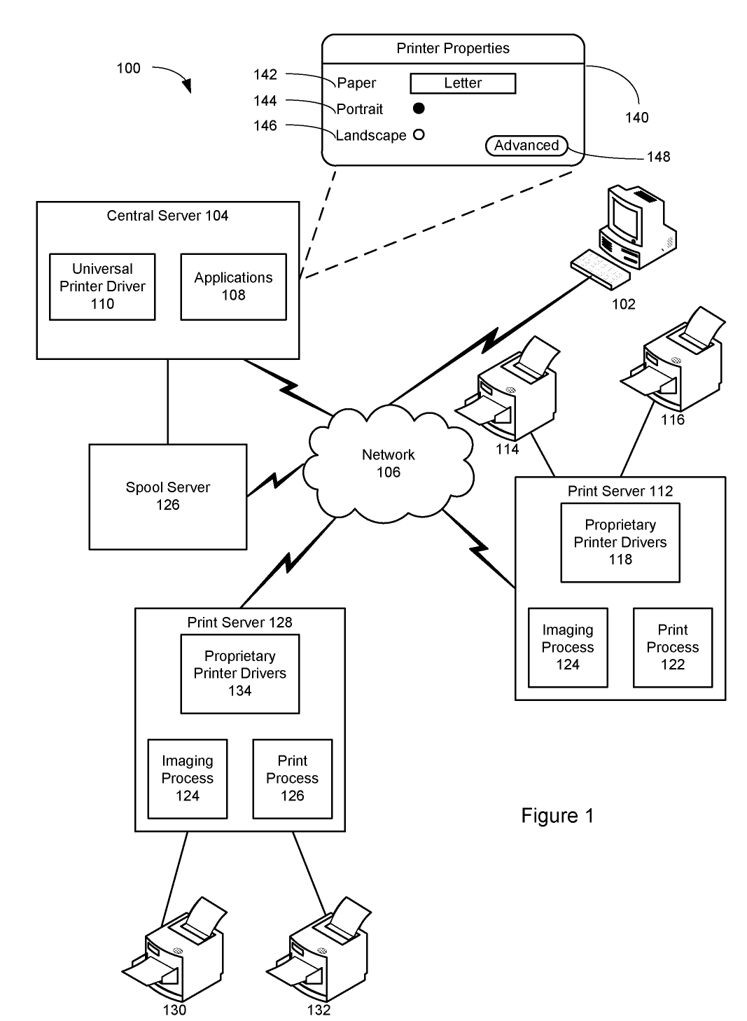

FIG. 1 shows an embodiment of a SbC, or distributed, computing environment 100 that permits thin clients to have access to extended printer properties. A thin client 102 communicates with a central server 104, such as a Citrix MetaFrame™ server or Microsoft Terminal Services™ server, over a network 106. The central server 104 can be a single server, or a server farm. The network 106 can be any suitable network, including a Wide Area Network (WAN), such as the Internet, or a Local Area Network (LAN). The client 102 and central server 104 will typically establish a virtual private channel using proprietary protocols, such as Remote Desktop Protocol (RDP) and Independent Computing Architecture (ICA). RDP is a multi-channel protocol that is supported by Microsoft Terminal Services servers, while ICA is a proprietary protocol for Citrix systems. Embodiments of the system and its operation will be described in terms of server-based computing using Microsoft Terminal Services™ or Citrix MetaFrame™. However, as will be clear to those of ordinary skill in the art, the solutions described herein are equally applicable to server-based computing, or distributed computing, environments that implement a Virtual Desktop Infrastructure (VDI), where the central server provides numerous virtual machines to thin clients.

Thin client devices were originally conceived as solid-state devices that contained just enough software out-of-the-box to connect to a SbC environment. Solid-state devices typically do not contain hard drives. Since all application logic runs on the servers, such thin devices are administratively light and inexpensive, and require only a minimal amount of software to be installed. Thin clients are now often small computers (also known as “rich” clients). These newer thin clients contain hard drives and administrators can install some client software on to the thin device. In the context of SbC printing, a fat client or thin client is defined by how the client device prints from within a SbC session. A fat client is defined as any client device responsible for processing print jobs returned to it, which ultimately requires additional locally installed software, such as printer drivers, to accomplish this task. A thin client is defined as any client device that does not receive or process print jobs directly, and therefore requires other server-side processes to render jobs on behalf of the client device. Such thin clients include terminals, network computers, workstations, desktop computers, laptop computers, and handheld devices, such as personal digital assistants (PDAs) and mobile handsets. Local applications may be installed and executed directly on the client device, which will still be considered a thin client for the purposes of the present description if its print jobs are processed in the network when in a SbC session.

The applications 108 used by the thin client 102 are typically hosted on the central server 104. All user inputs are passed seamlessly to the central server 104, where they are executed, and the output returned to the client 102 in real-time, or near real-time. A universal printer driver 1 10 is also resident on the central server 104. When a user wishes to print from the thin client 102, the print request is passed to the central server 104. The universal printer driver 110 creates a print job, preferably in a format such as PDF. The print job is then transmitted to a print server 112 that supports a plurality of printer devices, such as printers 114 and 116. Examples of printer devices include conventional printers, such as laser printers, bubblejet printers, inkjet printers, and multi-purpose machines that combine, printing, faxing and/or photocopying capabilities, and also include PDF printers, and desktop facsimile applications. The proprietary printer drivers 118 associated with each of printers 114 and 116 are loaded on print server 112, and stored in memory. Print server 112 also includes a print process 122 for rendering the print job in accordance with the printer properties defined for the selected printer, and an imaging process 124, the operation of which will be described in greater detail below. The print server 112 uses the proprietary, or native, print drivers 118 to render the print jobs in the print process 122. Where the print jobs are provided in PDF, the print process can include a PDF interpreter, or, in cases where Adobe Acrobat Reader is installed on the print server 112, Adobe's rendering engine can be used by the print process 122.

Where the system 100 includes multiple print servers, a spool server 126 can be interposed between the central server 104 and the multiple print servers. In FIG. 1, two print servers 112 and 128 are shown. Two printer devices 130 and 132 are attached to printer server 128, and proprietary printer drivers 134 for each attached printer are present at print server 128. Print server 128 is also provided with a print process 122 and an imaging process 124. The spool server 126 acts as a messaging hub between the central server 104 and the multiple print servers. Print jobs generated by the universal printer driver 110 are routed to the spool server 126 and distributed to the appropriate print server for printing. Each print server can, for example, periodically poll the spool server 118 for print jobs for which it is responsible. The print jobs could, likewise, be periodically pushed to the appropriate printer servers. Communication between the central server 104, spool server 126 and the printer servers 112 and 128 can, for example, be accomplished via a bidirectional tunneling solution over a TCP connection, or other suitable secure connection. As will be clear to those of skill in the art, the spool driver 126 is not required to implement the present invention, particularly where there is only a single print server attached to the network.

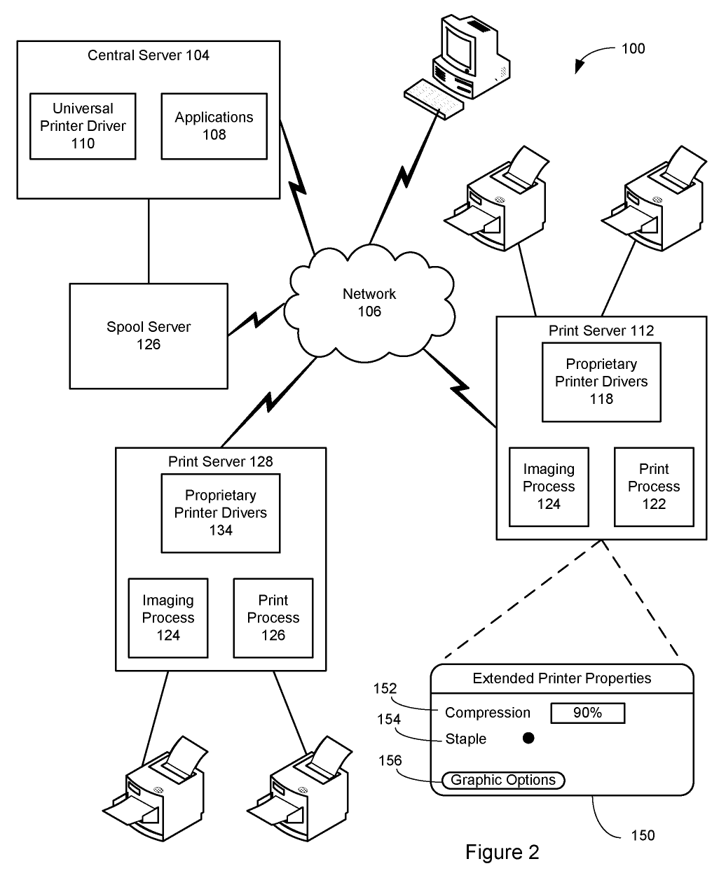

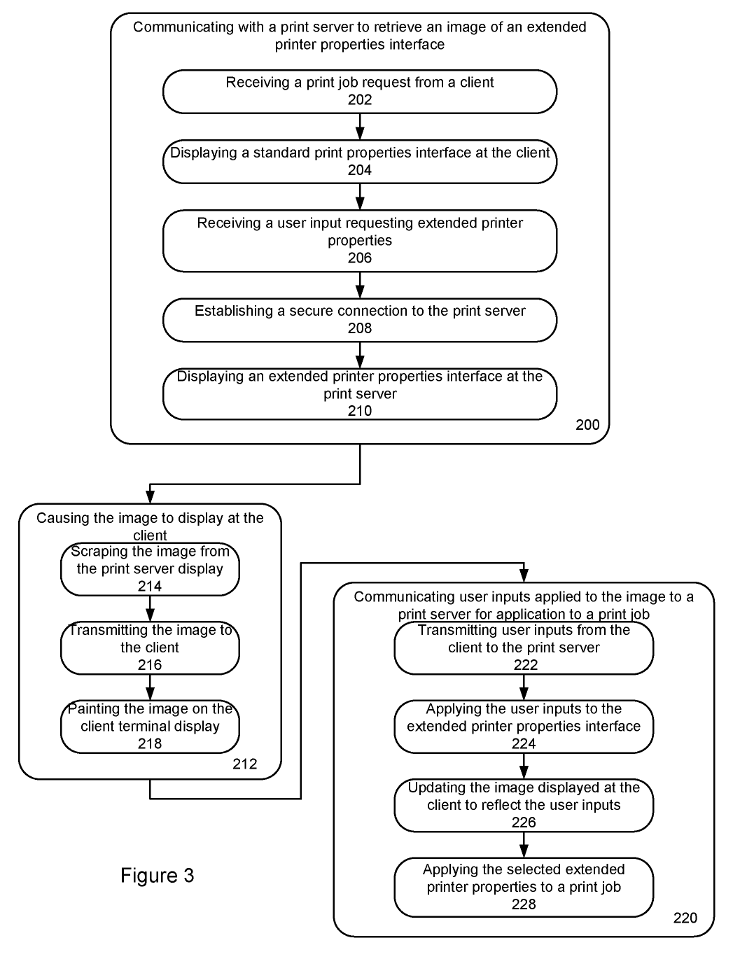

The method for providing extended printer properties to a client in a server-based computing environment will now be described with reference to FIGS. 1 and 2 and the flowchart of FIG. 3. To illustrate the operation of the present invention, it is assumed that the user of client device 102 wishes to print to printer 114 attached to printer server 112. The method generally comprises communicating with the print server 112 associated with a printer 114 to retrieve an image of an extended printer properties interface, or dialog box, for the printer 114 (step 200). To initiate this process, the user can make a print job request (step 202) by, for example, clicking on ‘Print . . . ’. The installed universal print driver displays a standard printer properties interface 140 to the client 102 (step 204). Alternately, the client 102 can include the capability to display the standard printer properties interface 140 directly. The standard printer properties interface includes standard printer properties, such as paper size 142 and portrait and landscape buttons 144 and 146. The standard printer properties interface also includes means to invoke the extended printer properties for the requested printer. These means can include the button 148 marked “Advanced”, an “Advanced” tab, or any other suitable graphical user interface means to access the extended printer properties. Once the user clicks on, or otherwise selects, the Advanced button 148 (step 206), the central server 104 establishes a secure connection with the print server 112 (step 208) where the selected printer is installed. The secure connection can, for example, use suitable tunneling protocols to establish a fast bidirectional tunnel between the central server 104 and the print server 112.

To identify the correct printer server associated with the requested printer, the central server 104 can, for example, send an identification of the requested printer to the spool server 126. Depending on the particular implementation, the spool server 126 can, for example, have details of the printers served by the various print servers in the network, and can mark the request with an identification of the printer server associated with the requested printer, and transmit the request accordingly.

Once the print server 112 receives a request for extended printer properties, it accesses the printer driver associated with the requested printer, and displays the native extended printer properties interface 150 at the print server 112 (step 210), as shown in FIG. 2. The extended printer properties are the advanced, or printer-specific, features, defined by the printer driver, such as image compression 152, stapling function 154, and graphic options 156. The image is then caused to be displayed at the client (step 212). An image, or snapshot, of the extended printer properties interface 150 is then grabbed by the imaging process 124 (step 214). The image can, for example, be grabbed by taking a screen shot of the image displayed at the print server 112, or by scraping the printer server display information. The image process can include a suitable screen scraper to retrieve the necessary images. The image is then transmitted to the client 102 (step 216), where it is displayed, or painted, onto the client display (step 218).

The user can then provide user inputs that are communicated to the print server for application to the print job (step 220). The user interacts with the displayed image. All user inputs or selections, including mouse clicks and keystrokes, are forwarded to the print server 112 via the central server 104 (step 222). The user inputs are applied to the original extended printer properties interface 150 displayed at the print server 112 (step 224). Any changes to the image that result from the user inputs being applied to the original extended printer properties interface 150 are transmitted back to the client 102 (via the central server 104), and are preferably applied to the client's “painted” image in real time, or near real-time (step 226). Only those portions of the image that are changed need to be transmitted back to the client 102. As further changes are made, further updated portions of the scraped image can be sent. Assuming network latency is not significant, the user experience is similar to interacting with a resident dialog box.

Once the user has finished modifying the printing preferences through interaction with the image of the extended printer properties interface, and clicks ‘OK’ or otherwise indicates completion, the selected preferences are then applied to the print job by the print process 122 (step 228). For example, in a Windows environment, the DEVMODE, or printer properties information store to be applied to the print job, is gathered and affixed to the print job. The print job can be transmitted to the print server 112 with the initial request for extended printer properties, or can be sent by the central server 104 once the user has finished modifying the extended printer properties. The print job can be transmitted to the print server in portable document format, or other format supported by the universal printer driver 110.

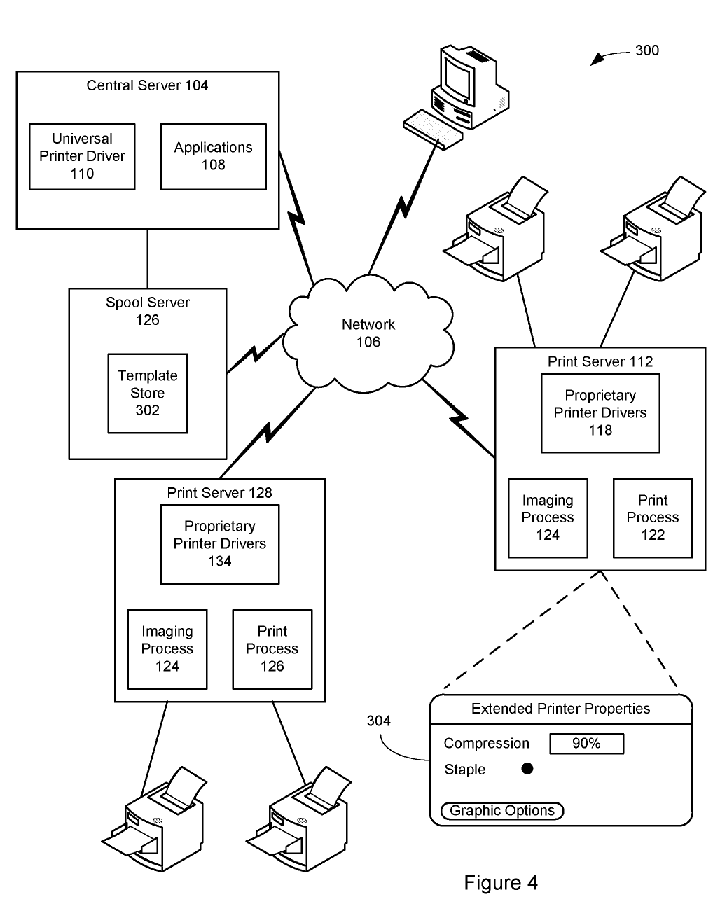

A further embodiment of the system is shown in FIG. 4. A description of those elements previously described in relation to FIGS. 1 and 2 is not repeated. The system 300 of FIG. 4 permits a user's previous extended printer properties preferences to be stored in a template store 302. The template store 302 is shown at the spool server 126; however, as will be appreciated by those of skill in the art, templates can be stored elsewhere in the system, or can form part of the user's profile stored at the central server 104. When the user wishes to access the extended printer properties for a particular printer for which previously stored template information exists, the template information is sent to the print server 112 with the print job request. The previously-stored set of extended printer property preferences can be applied directly to the extended printer properties interface 304 before it is first scraped or grabbed. In this way, the user does not have to make repetitive selections in every SbC session.

As will be appreciated, the present method and system for providing extended printer properties to a thin client have a number of advantages. The thin client device does not to have any local printer drivers installed, nor does it need to be physically connected to a local printer. Proprietary printer drivers associated with particular printers only need to be loaded on to their respective print servers, which can be easily accomplished when a printer is initially being installed. The present invention permits both standard and extended printer properties to be displayed at a thin client terminal without the need for any extra software, such as printer drivers, to be loaded on the client device. This permits organizations to improve productivity by allowing users in the SbC environment to print to any network-connected printer while giving the user a full range of access to the manufacturer's extended printer properties specific to the selected printer. The user is provided with a seamless, driver-less and full-featured printing experience.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method for providing extended printer properties to a client in a server-based computing environment, comprising:
communicating with a print server associated with a printer device to retrieve an image of an extended printer properties interface for the printer device;
causing the image of the extended printer properties interface to display at the client;
communicating user inputs input by a user on the image of the extended printer properties interface to the print server for application to a print job.

2. The method of claim 1, further comprising first receiving a request for extended printer properties from the client.

3. The method of claim 2, wherein receiving the request for extended printer properties comprises receiving a print job request from the client.

4. The method of claim 1, wherein communicating with the print server associated with the printer device to retrieve an image of the extended printer properties interface for the printer device comprises retrieving a template image of the extended printer properties interface for the printer device.

5. The method of claim 4, wherein the template image is associated with the client.

6. The method of claim 4, wherein the template image is associated with the user.

7. The method of claim 1, wherein communicating with the print server comprises establishing a secure connection with the print server.

8. The method of claim 7, wherein communicating with the print server comprises establishing a secure connection using a tunneling protocol over a Transmission Control Protocol (TCP) connection.

9. The method of claim 1, wherein causing the image of the extended printer properties interface to display at the client comprises scraping the image at the print server, and displaying the scraped image at the client.

10. The method of claim 1, wherein communicating user inputs input by the user on the image of the extended printer properties interface comprises receiving the user inputs at a central server in communication with the client and relaying the received inputs to the print server.

11. The method of claim 1, further comprising updating the image displayed at the client in accordance with the user inputs.

12. The method of claim 11, wherein updating the image displayed at the client comprises transmitting only an updated portion of the image to the client.

13. The method of claim 11, wherein the updating the image occurs in real-time.

14. The method of any one of claims 1, further comprising transmitting the print job to the print server in portable document format.

15. A print server for providing extended printer properties to a client in a server-based computing environment, comprising:
a memory storing a printer driver for a printer device associated with the print server, the printer driver including extended printer properties;
an imaging process to provide an image of an extended printer properties interface associated with the printer driver to a client and to receive user inputs related to the extended printer properties interface to define user selections of the extended printer properties;
a print process to apply the user selections to a print job.

16. The print server of claim 15, wherein the extended printer properties interface is an extended printer properties dialog box.

17. The print server of claim 15, further comprising a communications port to establish a secure communication channel with the client.

18. The print server of claim 15, wherein the secure communication channel comprises a tunnel established according to a tunneling protocol over a TCP connection.

19. The print server of claim 15, wherein, on receipt of user inputs, the imaging process updates the extended printer properties interface at the print server, and transmits an updated portion of the image to the client.

20. The print server of claim 19, wherein the updated portion of the image is transmitted in real-time.

21. The print server of claim 15, wherein the print job is provided to the print process in portable document format.

22. A distributed computing network providing extended printer properties to a client, comprising:
a central server to receive, from the client, a request for extended printer properties associated with a networked printer device;
a print server in communication with the central server, the print server having loaded thereon a printer driver associated with the networked printer device, and having an imaging process to provide a snapshot of an extended printer properties interface associated with the printer driver for display at the client, and to receive user selections defining extended printer properties to apply to a print job.

23. The distributed computing network of claim 22, wherein the client operates as a thin client.

24. The distributed computing network of claim 22, further comprising a spool server interposed between the central server and the print server, the spool server spooling print jobs for a plurality of print servers.

25. The distributed computing network of claim 22, wherein the extended printer properties interface is an extended printer properties dialog box.

26. The distributed computing network of claim 22, further comprising a template store for storing previous user selections of the extended printer properties, and wherein the imaging process applies the previous user selections to the extended printer properties interface prior to providing the snapshot.

27. The distributed computing network of claim 22, wherein the print server communicates with the central server over a secure communication channel.

28. The distributed computing network of claim 27, wherein the secure communication channel comprises a tunnel established according to a tunneling protocol over a TCP connection.

29. The distributed computing network of claim 22, wherein the central server is a Citrix Metaframe™ server.

30. The distributed computing network of claim 22, wherein the central server is a Microsoft Terminal Services™ server.

31. The distributed computing network of claim 22, wherein the central server implements a Virtual Desktop Infrastructure.

32. The distributed computing network of claim 22, wherein, on receipt of user selections, the imaging process updates the extended printer properties interface at the print server, and transmits an updated portion of the image to the client.

33. The distributed computing network of claim 32, wherein the updated portion of the image is transmitted in real-time.

34. The distributed computing network of claim 22, wherein the print job is provided to the print process in portable document format.
